(19) United States
(12) Patent Application Publication
(10) Pub. No.: US 2020/0034119 A1
(43) Pub. Date: Jan. 30, 2020

(54) Translating User Inputs Into Discretely Functional Styled Standalone Web and Mobile Software Features

(71) Applicant: Frank, Inc., New York, NY (US)

(72) Inventors: Thomas Isaac McLaughlin, New York, NY (US); Karim Antoine Sabri, New York, NY (US)

(73) Assignee: Frank, Inc., New York, NY (US)

(21) Appl. No.: 16/446,913

(22) Filed: Jun. 20, 2019

Related U.S. Application Data
(60) Provisional application No. 62/703,398, filed on Jul. 25, 2018.

(51) Int. Cl. G06F 8/34; G06F 17/24; G06F 8/38; G06F 17/22

(52) U.S. Cl. CPC G06F 8/34; G06F 17/2247; G06F 8/38; G06F 17/24

(57) ABSTRACT

A method for translating user inputs into discretely functional styled standalone features includes receiving a feature selection associated with a front-end user interface element configured for a client-side application from a user device at a designer-developer application. For each feature of the feature selection, the method identifies a data exchange format of the feature and determines whether the feature selection indicates a change to the feature. When the feature selection indicates the change to the feature, the method maps the change to an appropriate web-development language based on the type of edit associated with the change and updates the data exchange format for the feature of the feature selection based on the change. The method also receives a request for the front-end user interface element and communicating the data exchange format for each feature associated with the front-end user interface element of the request.

### CROSS REFERENCE TO RELATED APPLICATIONS

This U.S. patent application claims priority under 35 U.S.C. § 119(e) to U.S. Provisional Application 62/703,398, filed on Jul. 25, 2018. The disclosure of this prior application is considered part of the disclosure of this application and is hereby incorporated by reference in its entirety.

### TECHNICAL FIELD

This disclosure relates to translating user inputs into discretely functional styled standalone web and mobile software features.

### BACKGROUND

Users of applications demand increasingly complex applications to load at the speed of light and function seamlessly across computing devices. Application designers or design teams generally invest many hours, days, or weeks perfecting the designs for front-end features for a particular application. The designers then hand the designs for the front-end features over to developers or computer software engineers, who again spend hours, days, or weeks writing computer code to recreate those design features. This designer/developer paradigm common to the application industry is extremely inefficient, requiring the developers to reinvent the wheel with respect to each new feature. Moreover, the computer code required to render each front-end feature or component (e.g., a login feature, a registration feature, a user profile feature, a content or news feed, a navigation bar, a media upload feature, a map and location feature, and other common features) is largely the same across different applications for the same or similar features. Nevertheless, the developers/computer software engineers are often required to develop these features from scratch each time in a process that may take several days or weeks. A solution is needed that can bridge the gap between the feature design and development processes. Companies relying on applications need a solution to more efficiently and effectively design and deploy features on their applications (e.g., by removing the need for a developer/computer software engineer with regard to some or all front-end Web or mobile application features).

### SUMMARY

One aspect of the disclosure provides a method for translating user inputs into discretely functional styled standalone web and mobile software features. The method includes receiving, at data processing hardware, a feature selection from a user device at a designer-developer application. The feature selection indicates at least one feature from features of the designer-developer application. The at least one feature is associated with a front-end user interface element configured for a client-side application. For each feature of the feature selection, the method further includes identifying, by the data processing hardware, a data exchange format of the feature and determining, by the data processing hardware, whether the feature selection indicates a change to the feature. Here, the change indicates a type of edit corresponding to a connectivity edit, a visual edit, or a content edit. When the feature selection indicates the change to the feature, the method further includes mapping the change to an appropriate web-development language based on the type of edit associated with the change and updating, by the data processing hardware, the data exchange format for the feature of the feature selection based on the change. The method also includes receiving, at the data processing hardware, a request for the front-end user interface element and communicating, by the data processing hardware, the data exchange format for each feature associated with the front-end user interface element of the request.

Implementations of the disclosure may include one or more of the following optional features. In some implementations, the request initiates from a page load request at run-time for a page of the client-side application. In these implementations, the page load request includes an authentication key where the authentication key authenticates access for the client-side application to retrieve one or more data exchange formats from the designer-developer application. Moreover, in these implementations, the page load request includes a project identifier that indicates one or more front-end user interface elements embedded in the client-side application.

In some configurations, the data exchange format is a java script object notation (JSON) format. In some examples, the data exchange format is an extensible markup language (XML) format. Additionally, communicating the data exchange format for each feature may include processing the data exchange format into a respective web-development language and transmitting the respective web-development language corresponding to the data exchange format to a codebase of the client-side application. In some examples, the front-end user interface element includes a plurality of features. In some configurations, receiving the feature selection occurs at a graphical user interface of the designer-developer application.

In some examples, the data exchange format includes an identifier for the feature and the request for the front-end user interface element includes at least one request identifier. In these examples, the method also includes determining that the at least one request identifier of the request matches a respective identifier associated with a respective feature of the designer-developer application. Here, communicating the data exchange format for each feature associated with the front-end user interface element of the request includes communicating the data exchange format with the respective identifier that matches the at least one request identifier.

In some implementations the method maps the change to the appropriate web-development language based on the type of edit associated with the change. When the change is the connectivity edit, the method includes mapping the change a valid java script. When the change is the visual edit, the method includes mapping the change to a valid cascading style sheets (CSS) and a valid first hyper-text markup language (HTML). When the change is the content edit, the method includes mapping the change to a valid second hyper-text markup language (HTML). In some configurations, identifying the data exchange format of the feature further includes identifying a default data exchange format from the features of the designer-developer application corresponding to the feature and forming the data exchange format for the feature by assigning a unique identifier (UID) to the default data exchange format corresponding to the feature.

Another aspect of the disclosure provides a system for translating user inputs into discretely functional styled standalone web and mobile software features. The system includes data processing hardware and memory hardware. The memory hardware is in communication with the data processing hardware and includes instructions that when executed by the data processing hardware perform operations. The operations include receiving a feature selection from a user device at a designer-developer application. The feature selection indicates at least one feature from features of the designer-developer application. The at least one feature is associated with a front-end user interface element configured for a client-side application. For each feature of the feature selection, the operations include identifying a data exchange format of the feature and determining whether the feature selection indicates a change to the feature. Here, the change indicates a type of edit corresponding to a connectivity edit, a visual edit, or a content edit. When the feature selection indicates the change to the feature, the operations include mapping the change to an appropriate web-development language based on the type of edit associated with the change and updating the data exchange format for the feature of the feature selection based on the change. The operations also include receiving a request for the front-end user interface element and communicating the data exchange format for each feature associated with the front-end user interface element of the request.

In some configurations the request initiates from a page load request at run-time for a page of the client-side application and whereby the page load request includes an authentication key, the authentication key authenticating access for the client-side application to retrieve one or more data exchange formats from the designer-developer application and the page load request includes an authentication key, the authentication key authenticating access for the client-side application to retrieve one or more data exchange formats from the designer-developer application.

Additionally, the data exchange format may be a java script object notation (JSON) format. In some examples, the data exchange format is an extensible markup language (XML) format. In some implementations, the operation of communicating the data exchange format for each feature includes processing the data exchange format into a respective web-development language and transmitting the respective web-development language corresponding to the data exchange format to a codebase of the client-side application.

In some examples, the data exchange format includes an identifier for the feature and the request for the front-end user interface element includes at least one request identifier. In these examples, the operations further include determining that the at least one request identifier of the request matches a respective identifier associated with a respective feature of the designer-developer application, and communicating the data exchange format for each feature associated with the front-end user interface element of the request includes communicating the data exchange format with the respective identifier that matches the at least one request identifier.

In some implementations, the operation maps the change to the appropriate web-development language based on the type of edit associated with the change. When the change is the connectivity edit, the operations may include mapping the change a valid java script. When the change is the visual edit, the operations may include mapping the change to a valid cascading style sheets (CSS) and a valid first hyper-text markup language (HTML). When the change is the content edit, the operations may include mapping the change to a valid second hyper-text markup language (HTML). In some examples, the operation of identifying the data exchange format of the feature further includes identifying a default data exchange format from the features of the designer-developer application corresponding to the feature and forming the data exchange format for the feature by assigning a unique identifier (UID) to the default data exchange format corresponding to the feature.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example network environment.

FIGS. 2A-2C are schematic views of example feature systems interacting with application(s) of the network environment.

FIGS. 3A-3C are schematic views of example features for a feature system.

FIGS. 4A and 4B are schematic views of example feature identifiers for a feature.

FIG. 5A is a schematic view of an example front-end element including features of a feature system.

FIG. 5B is a schematic view of an example of feature configuration data for a feature of a feature system.

FIGS. 6A and 6B are schematic views of example code for functionality of a library of the feature system.

FIG. 7 is a flowchart of an example arrangement of operations for a method of translating user inputs into discretely functional styled standalone features.

FIG. 8 is a schematic view of an example computing device used to implement the systems and methods of translating user inputs into discretely functional styled standalone features.

Like reference symbols in the various drawings indicate like elements.

### DETAILED DESCRIPTION

Software applications (also referred to as applications, apps, or programs) have become ubiquitous with everyday life. Generally, applications seek to offer users an efficient, easy to use platform that is readily available (e.g., accessible at their fingertips). Many people access and/or rely upon applications each day for their products and services. For instance, a majority of people manage and/or organize their personal life by applications. Typically, computers are heavily used to execute these applications. For instance, mobile phone use often revolves around mobile applications. Applications allow people to access and to manage finances (e.g., banking applications, budgeting applications, investment applications, etc.), communication (e.g., email applications, social media applications, real-time communication applications, messaging applications, etc.), retail (e.g., shopping applications, etc.), navigation (e.g., global positioning system applications, map applications, etc.), entertainment (e.g., media streaming applications, news, media storage applications, gaming applications, etc.), transportation (e.g., ride share applications, public transit applications, etc.), or other tasks (e.g., personal assistant applications).

In some examples, applications are web-based applications. Generally speaking, a web-based application is executed by an application (i.e., software program) referred to as a web browser that retrieves remote resources from web servers. Here, the web browser receives the remote resources from the web servers and displays these remote resources as web pages. For instance, the internet commonly uses web browsers to display and/or to access websites (e.g., by web addresses) with web-based content (e.g., content in languages such as Hypertext Markup Language (HTML), Extensible Markup Language (XML), etc.). Web-based applications may be accessible via a web browser with any device that has access to a network in communication with a host (e.g., computing resources such as server(s)) of the web-based application.

Another form of applications is mobile-based applications. Mobile-based applications (also referred to as mobile applications) are applications designed to run on a mobile device (e.g., executable on mobile devices such as cellular phones, smart phones, smart watches, internet of things (IoT) devices, tablets, etc.). Unlike integrated software systems found on a dedicated computer device (e.g., a desktop or a laptop), mobile applications are often limited to particular functionality of a mobile environment. In early evolution, mobile applications were built for a particular function to be compatible with limited resources for portable devices with smaller footprints than dedicated hardware. Yet today mobile applications may continue to have specific functions although processors have evolved to also have proportionally smaller footprints. Much like web-based applications, mobile applications are accessible from any mobile device with a network (e.g., cellular network or wireless network) able to communicate with a remote system (e.g., server) hosting the mobile application. Additionally or alternatively, the application may be a desktop application or an application that functions across more than one application platform (e.g., an application that has a mobile version and a web-based version).

As applications meld with how people operate, this wide variety of applications needs to be designed, developed, and/or managed to work effectively. Old applications get face-lifts and/or incorporate new functionality. New applications integrate old functionality and may blend it with new or custom functionality. Some applications may look and feel different, but contain similar functionality behind the scenes. For instance, a login prompt for an application may include different colors or styles yet, from a programming standpoint, include a common set of features to perform the login functionality.

Traditionally, creation, maintenance, and/or updates to an application may involve multiple parties with different skillsets. For instance, each application has an aesthetic look and feel coordinated by a designer (e.g., a web designer for web-based applications). A designer is generally responsible for visual elements of an application such as layout, organization, color schemes, typesetting, or other aesthetic elements that impact an application user's experience (UX). In some examples, the designer is also involved with content generation or content editing for the application. Often, a designer communicates an application's design or updates to the design to a developer. The developer uses front-end development technology (e.g., hypertext markup language (HTML), JavaScript, cascading style sheets (CSS), hypertext preprocessor (PHP), etc.) to encode the design into a functional application. In some implementations, an application owner who owns the application employs the designer and/or the developer to implement his/her desired vision and function for the application.

With multiple entities, the overall time to implement and/or to maintain an application may greatly vary. Each entity has an individual cycle (e.g., design cycle, development cycle, review cycle/test cycle, etc.) with inevitable feedback loops between these cycles as a designer, a developer, and/or an application owner communicate. Individually and/or collectively, these cycles cost time and money that may impact, for example, a time to market for goods and/or services or a time an application is offline undergoing maintenance. In other words, each entity involved and, in some cases, a need for the entities to interact with each other may detrimentally affect an applications ability to adapt and to change during deployment and/or implementation.

Certain web-based or mobile application development platforms may exist that allow designers to design web-based or mobile applications that require little or no custom coding. However, such platforms often require users to develop the entirety of a user's application within the same platform. Therefore, these platforms are unable to incorporate discrete features into proprietary codebases; thus, providing very little flexibility to application developers. Here, the proposed system (e.g., the feature system 200 and/or the designer-developer application 140) provides more flexibility to designers to create standalone front-end application features that are codebase agnostic such that these features can be fully integrated into proprietary codebases created by various developers across a variety of platforms.

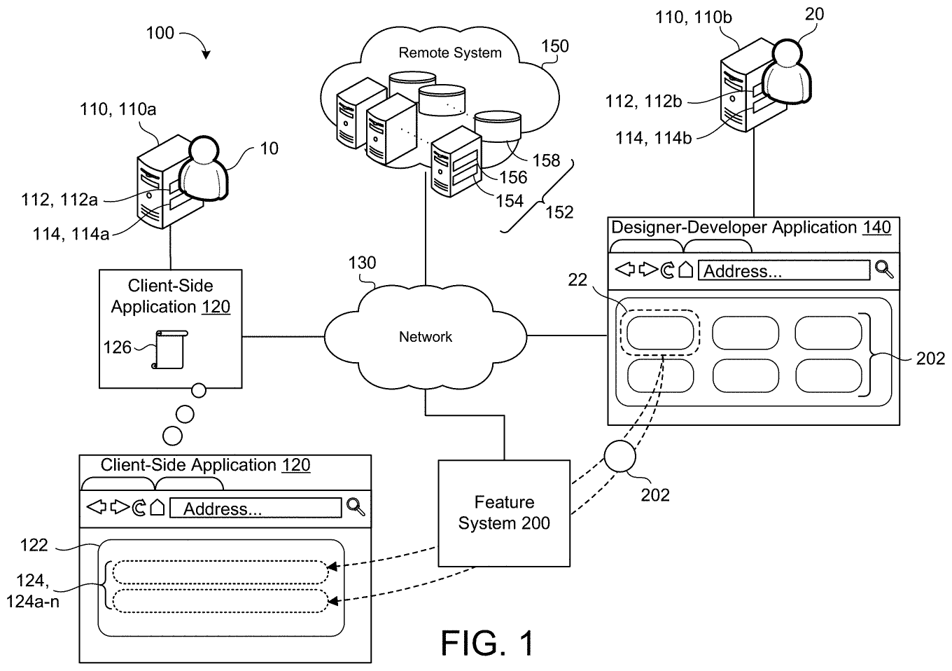

Referring to FIG. 1, in some implementations, the network environment 100 seeks to address these cycles associated with the application. For instance, the network environment 100 consolidates content-generation inefficiencies between entities for the designer-developer cycles. The network environment 100 includes a client 10 (also referred to as an end user 10) using a client device 110, 110a to interact with a client-side application 120 (also referred to as a front-end application) via a network 130. The client 10 generally refers to a user of the client-side application 120. For instance, when the client-side application 120 is a blog, the client 10 may be a blogger or a reader of the blog. To access the client-side application 120, the client device 110 may be any device compatible with the application type (e.g., web-based application, mobile application, desktop application, cross-platform application, etc.) of the client-side application 120. For example, when the client-side application 120 is a mobile application, the client device 110 is a device configured to execute mobile applications (e.g., a mobile device such as a mobile phone, a tablet, etc.). When the client-side application 120 is a web-based application, the client device 110 is a device configured to execute a web-browser application to navigate and to display the web-based application. For instance, FIG. 1 depicts the client-side application 120 as a web-based application accessible on a web browser at a web address.

In some implementations, a client-side application 120 includes a front-end user interface (UI) 122 with front-end elements 124, 124a-n (e.g., front-end user interface elements). These front-end elements 124 refer to portions of a client-side application 120 that execute some level of functionality (e.g., based on an input received from an action of the client 10). Although traditionally the designer and/or the developer generates the client-side application 120, FIG. 1 illustrates that a designer-developer application 140 may be used to generate all or some portion of the client-side application 120 (e.g., depending on a level of desired integration and/or complexity). The designer-developer application 140 is a program configured for at least one entity (e.g., a designer or a developer) to build features (e.g., features 202 from the feature system 200) into the front-end elements 124 of the front-end user interface 122. In order to generate these features, the designer-developer application 140 uses a feature system 200. In other words, the designer-developer application 140 is a program configured to interface with the feature system 200.

The feature system 200 is configured with functional components of a user interface (e.g., components for the front-end user interface 122) that perform common and/or custom client-side application functions. In some examples, the feature system 200 allows a single entity (referred to as a designer-developer or a system user 20) to function in a capacity as both a designer and a developer. The single entity, shown as a system user 20, may interact with the feature system 200 to customize pre-built features 202 of the feature system 200 or create unique features 202 (e.g., from a blank canvas). By using the feature system 200, the system user 20 may publish features 202 immediately upon creation or modification (e.g., editing) such that the features 202 are ready for use at a client-side application 120. Additionally or alternatively, the feature system 200 may allow the system user 20 to design a front-end (e.g., a front-end user interface 122) for the client-side application 120 without needing to write much or any code. This permits a greater number of people who may lack code writing skills (e.g., designers) to implement an application. In other words, less resources or specialty personal may be required to create or to maintain a client-side application 120. In some examples, it may allow a developer to focus on truly unique tasks associated with a client-side application 120 rather than commonly designed and/or non-complex features 202.

Devices 110, 110a-b, such as client devices 110a or user devices 110b, generally refer to any computing device or data processing hardware capable of executing an application. In some examples, each device 110 includes data processing hardware 112, 112a-b and memory hardware 114, 114a-b. Here, the memory hardware 114 may include databases or other storage configurations that store instructions executable on the data processing hardware 112. The data processor hardware 112 is configured to execute the instructions to perform operations. In some implementations, the devices 110 host all or parts of the application (e.g., desktop applications or mobile applications). In other implementations, the devices 110 are configured to communicate across the network 130 and access recourses of the remote system 150 to execute the application (e.g., web-based applications). Although the client device 110a and the user device 110b may be identically structured devices 110, for simplicity, the client device 110a is associated with the client user 10 accessing the client-side application 120, while the user device 110 is associated with the system user 20 interacting with the feature system 200 (e.g., by way of the designer-developer application 140).

In some examples, the client-side application 120 and/or the designer-developer application 140 is an application hosted by a remote system 150, such as a distributed system of a cloud environment, accessed via the client device 110a and/or the user device 110b. In some implementations, the client-side application 120 and/or the designer-developer application 140 is an application downloaded to memory hardware 114 of a device 110. Regardless of an access point to the client-side application 120 and/or the designer-developer application 140, the client-side application 120 and/or the designer-developer application 140 may be configured to communicate with the remote system 150 to access resources 152 (e.g., data processing hardware 154, memory hardware 156, or software resources 158). Access to resources 152 of the remote system 150 may allow the client-side application 120 and/or the designer-developer application 140 to be used across multiple application platforms and on different types of devices 110 without necessarily compromising functionality (e.g., for a mobile or web-based application).

FIG. 1 also illustrates on a high level that the designer-developer application 140 generates elements 124 of the client-side application 120. For instance, the system user 20 makes a feature selection 22 (e.g., indicated by dotted lines around a feature 202) at the designer-developer application 140 to select a feature 202 from the feature system 200. Here, as a designer-developer, the system user 20 selects a feature 202 that will generate an element 124 of the front-end user interface 122 of the client-side application 120. In some examples, the system user 20 selects more than one feature 202 to generate the element 124. In other words, an element 124 of the front-end interface 122 may be made up of multiple features 202. To illustrate, a login element 124 of a client-side application 120 may include more than one text input field, a submit/enter button, “forget your password/username” references, etc., each as separate features 202 that form the login element 124.

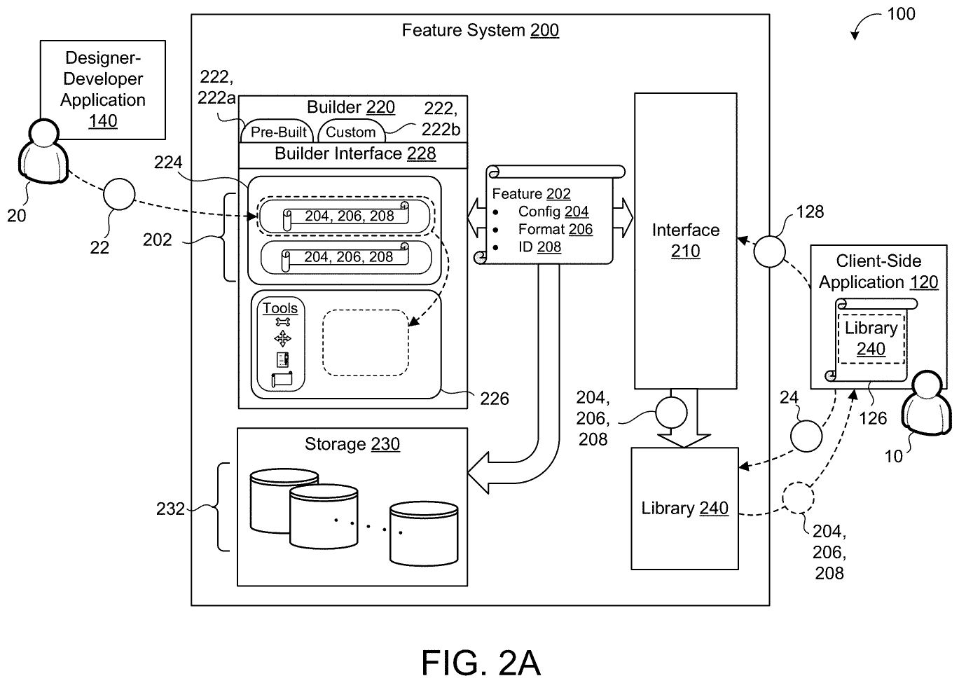

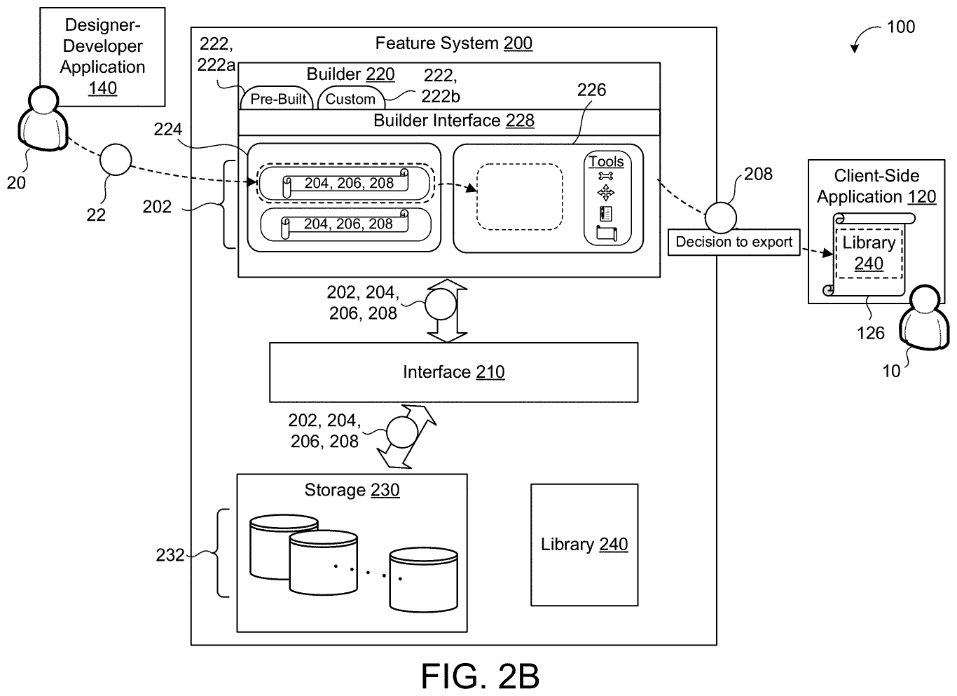

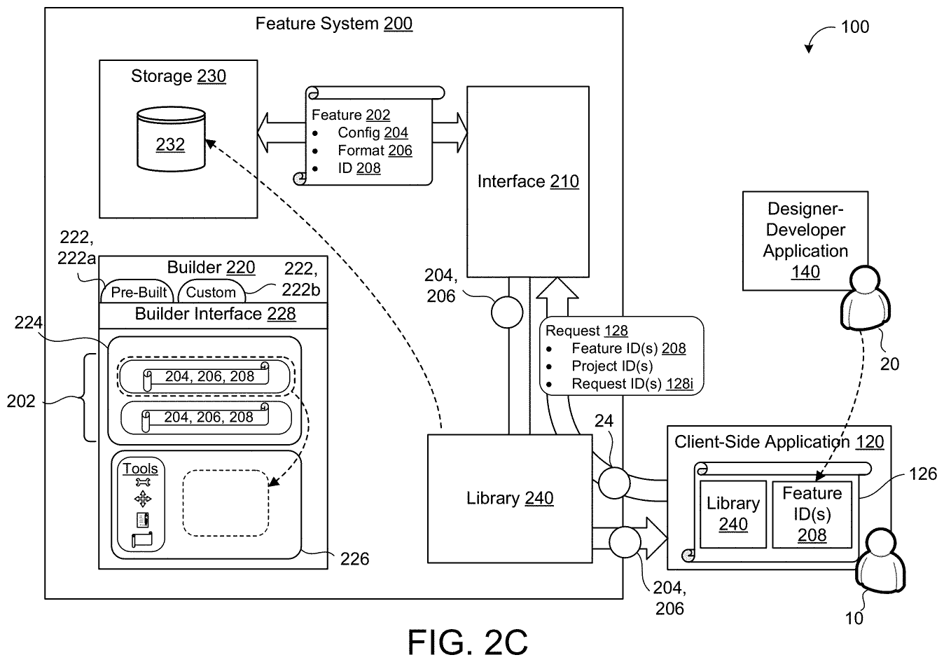

FIGS. 2A-2C are examples of the feature system 200. The feature system 200 generally includes an interface 210, a builder 220, storage 230, and a library 240 as subsystems. Each of these subsystems 210-240 performs a different role within the feature system 200 depending on the actions of the system user 20. These actions may include feature creation, feature editing, feature publishing, feature exporting, feature embedding, or feature loading among others. The interface 210 is configured as a means of communication between subsystems of the feature system 200. In other words, the interface 210 facilitates interaction between subsystems and/or other applications, such as the client-side application 120 or the designer-developer application 140. For example, in the case of the client-side application 120, the interface 210 is configured to deliver code (e.g., configuration data 204 in the form of the data-exchange format 206) corresponding to a feature 202 that forms an element 124 of the client-side application 120. In some configurations, the interface 210 is an application programming interface (API) that generally provides some layer of abstraction with resources (e.g., resources 112, 114, 152) and subsystems associated with the feature system 200. For example, the interface 210 simplifies interaction and use of the resources 152 of the remote system 150 that correspond to the feature system 200.

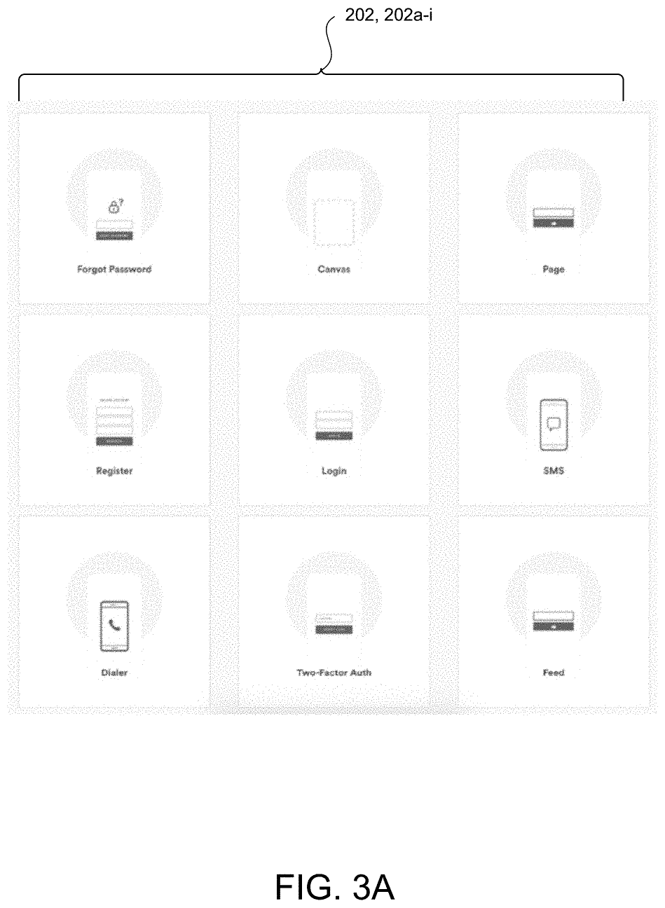

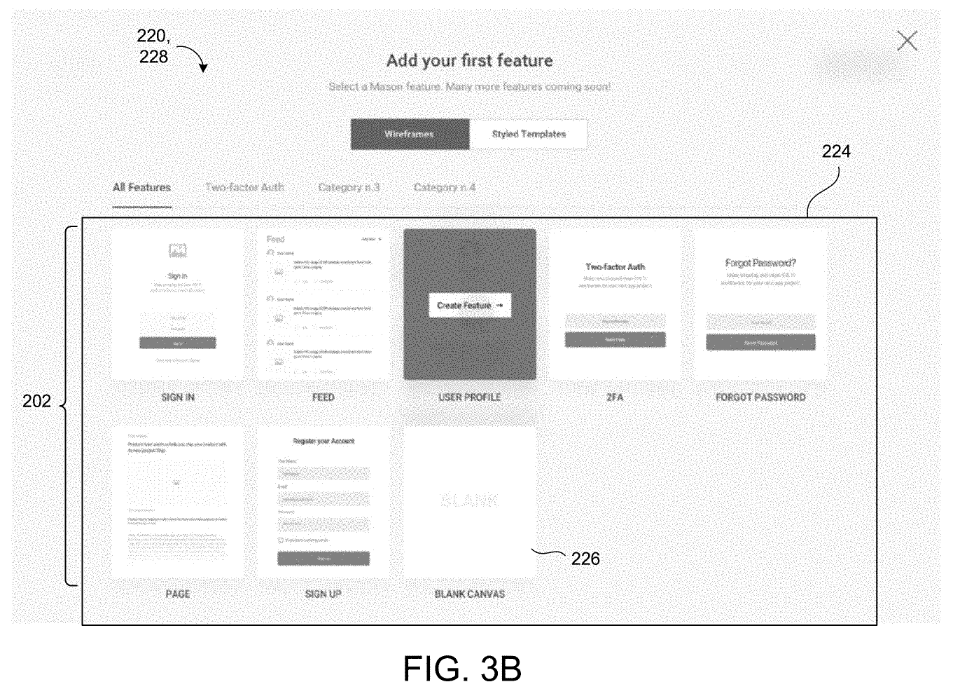

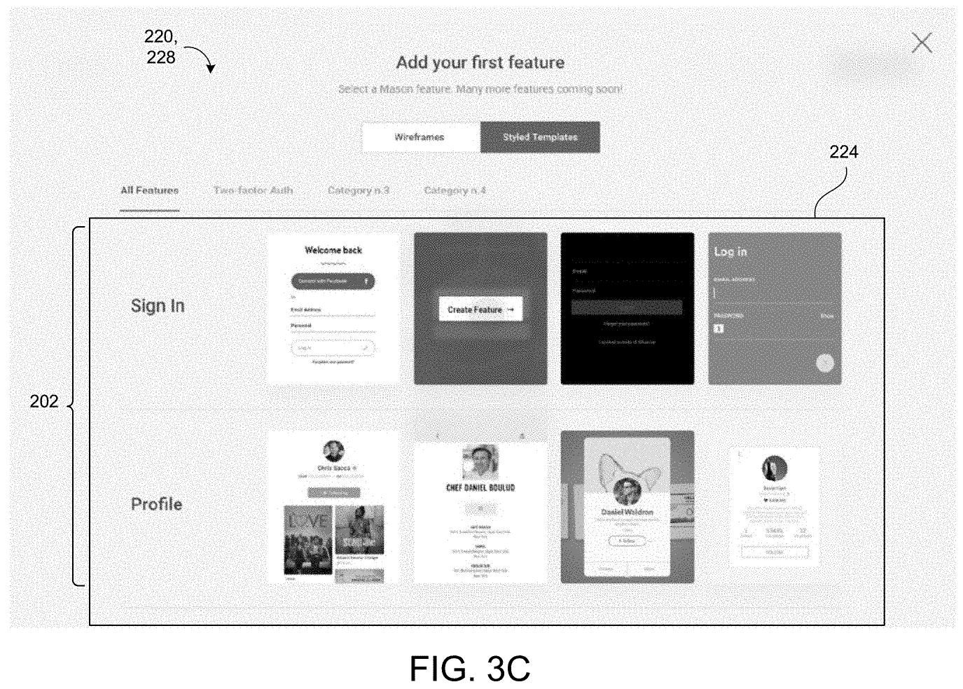

The builder 220 is a subsystem of the feature system 200 that is configured to construct a feature 202 (e.g., a graphical and/or textual feature). By being responsible for constructing a feature 202, the builder 220 generally enables the system user 20 to build a fully functional feature 202 (i.e., a feature 202 that is functional for a client-side application 120, such as an element 124 of the front-end UI 122). As previously mentioned, this may be as simple as selecting a pre-built feature 202 of the feature system 200 (e.g., a submit or cancel button) or a more complicated customized feature 202. In some configurations, to build features 202, the builder 220 includes different modes 222. For instance, the system user 20 toggles through these different modes 222 to build different types of features 202 (e.g., pre-built features 202 or customized features 202). In some implementations, the builder 220 includes a pre-built feature mode 222, 222a with a menu 224 of pre-built features 202. In other words, the pre-built features 202 are default features 202 already programmed by a developer of the feature system 200 (e.g., fully functional features 202 not built by the system user 20). Pre-built features 202 may correspond to features 202 that are common among client-side applications 120. Some examples include a login feature, a registration feature, a user profile feature, a content or news feed feature, a navigation bar feature, a chat feature, a forgot password feature, an SMS feature, a dialing feature, a canvas feature, a two-factor authentication feature, etc. (as shown in FIG. 3A with features 202, 202a-i). The menu 224 may display a feature library (i.e., a library corresponding to a compilation of features at the builder 220 that is different from the library 240) including some or all of the options available to the system user 20 as pre-built features 202. For instance, the menu 224 displays a quick-view for a pre-built feature 202 and/or a description of the pre-built feature 202.

In some implementations, the builder 220 includes a blank canvas mode 222, 222b with a blank canvas 226 enabling a system user 20 to build/customize a feature 202. This customization may range from changing visual aspects of a pre-built feature 202 to programming a feature 202 from scratch. For instance, the blank canvas mode 222b has tools for different types of customization. In some examples, the blank canvas mode 222b has visual-related tools for changing styles, colors, or typesets for a feature 202 (e.g., adding an image, changing the background, changing the style, changing the size, changing the position, changing the colors, changing the values, etc.). In some implementations, the blank canvas mode 222b includes coding tools configured to encode aspects of a feature 202 for front-end development (e.g., hypertext markup language (HTML), JavaScript, cascading style sheets (CSS), hypertext preprocessor (PHP), etc.). In some configurations, a system user 20 selects a pre-built feature 202 from the pre-built feature mode 222a and indicates (e.g., by making an editing selection) a desire to make changes to the pre-built feature 202 using functionality of the blank canvas mode 222b. Here, the system user 20 may drag the pre-built feature 202 onto the blank canvas 226 of the blank canvas mode 222b (or a simplified editing version of the blank canvas mode 222b) or, more generally, the feature system 200 transfers the pre-built feature 202 onto the blank canvas 226 upon a selection by the system user 20 to customize the pre-built feature 202.

In some examples, the builder 220 includes its own interface (i.e., a builder interface 228). Here, the builder interface 228 may provide a user experience (UX) with the builder 220 (e.g., as a graphical user interface (GUI) for the builder 220). For instance, the builder interface 228 provides a UX with the builder menu 224 or the blank canvas mode 222b. In some configurations, the interface 210 operates as the builder interface 228. In some implementations, the builder 220 uses the interface 210 to communicate with other subsystems of the feature system 200 and/or systems external to the feature system 200 (e.g., the system user 20 via the designer-developer application 140 or the client user 10 via the client-side application 120). For instance, the builder 220 accesses data from the storage 230 to generate functional features 202. In some examples, the builder 220 stores parts of, or entirely constructed, features 202 in the storage 230. In some configurations, the builder 220 edits or modifies a feature 202 that the builder 220 has already built such that the builder 220 retrieves the original feature 202 from storage 230 (e.g., via the interface 210) to make requested changes. Some examples of builder interfaces 228 are shown in FIGS. 3B and 3C.

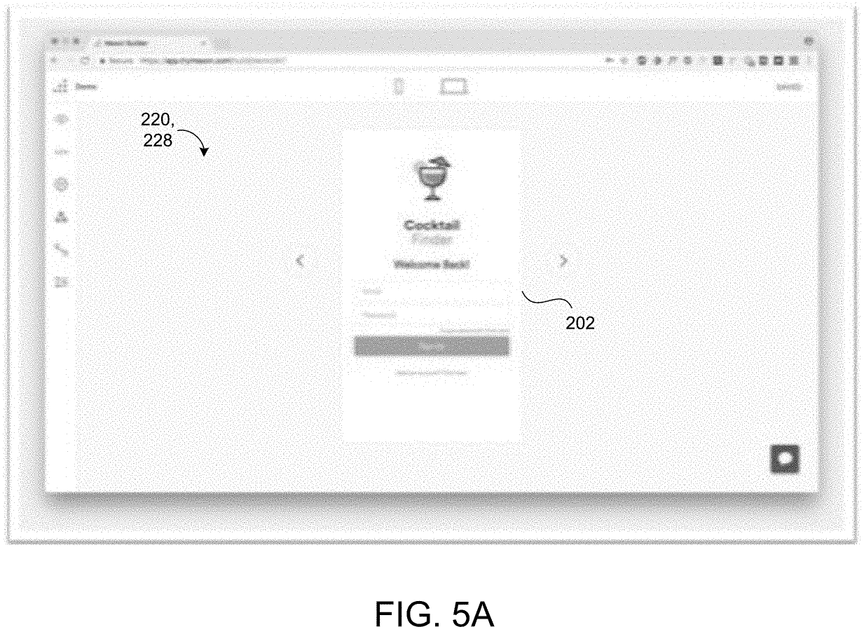

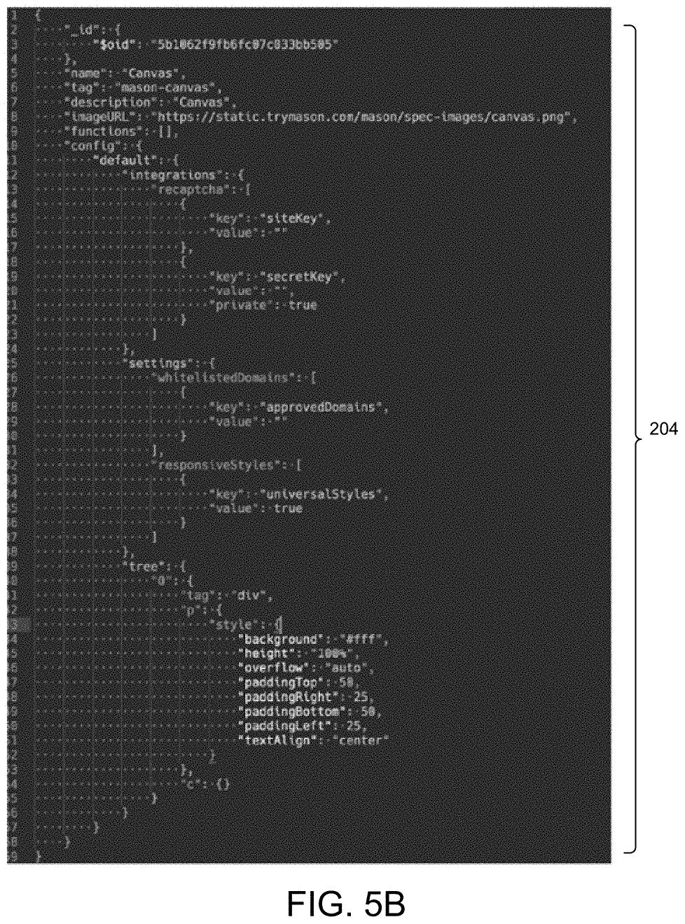

In some implementations, each feature 202 includes configuration data 204 (e.g., as shown in FIG. 5B). Although the configuration data 204 may be of varying complexities, the configuration data 204 generally refers to data that configures settings and/or parameters for a particular feature 202. In some examples, the feature system 200 generates feature configuration data 204 when the feature system 200 (e.g., the builder 220) generates a newly created or newly edited feature 202 or when the system user 20 selects a pre-built feature 202. In some configurations, as the feature system 200 customizes features 202, the feature system 200 modifies the feature configuration data 204 to enable a subsystem or an application to construct the customized feature 202 with the configuration data 204. In some implementations, pre-built features 202 have default feature configuration data 204 that has been developed previously by a developer of the feature system 200 such that the feature system 200 does not need to update the feature configuration data 204 when the system user 20 selects a pre-built feature 202. Additionally or alternatively, the feature configuration data 204 may include or reference an owner of the feature 202 (e.g., designate which system user 20 selects the feature 202) such that the feature system 200 modifies the feature configuration data 204 even when the selected feature 22 is a pre-built feature 202. Below is an example of feature configuration data 204 for a feature 202 (e.g., the feature 202 illustrated in FIG. 5A).

The feature configuration data 204 may be transmitted to an application (e.g., the client-side application 120 or the designer-developer application 140) by the interface 210. For examples, the interface 210 transmits the feature configuration data 204 for each feature 202 corresponding to one or more elements 124 of the client-side application 120 to a codebase 126 associated with the client-side application 120. In some implementations, the interface 210 transmits feature configuration data 204 for one or more feature 202 into other subsystems of the feature system 200 such as the storage 230 or the library 240.

Optionally, the feature configuration data 204 may include instructions (also referred to as intelligent analytics instructions) to perform intelligent analytics that identify the use (e.g., customization, modification, etc.) of a feature 202 with respect to the client-side application 120. A system user 20 may select one or more features 202 causing the intelligent analytics instructions to track and/or to record data related to how a client user 10 engages or interacts with an element 124 corresponding to that particular feature 202. For instance, the intelligent analytics instructions includes how many times, when, or where the client user 10 engages, interacts, or shares the particular element 124 or discrete features 202 of the element 124. Here, the intelligent analytics instructions may be one or more lines of JavaScript code.

In some examples, each feature 202 has an associated data exchange format 206. Generally, a data exchange format 206 refers to a data format that allows data to be shared between different applications (e.g., between the feature system 200, the client-side application 120, or the designer-developer application 140). For instance, the data exchange format 206 packages the feature configuration data 204 into a data format that allows the feature configuration data 204 of a feature 202 to be shared between different applications and/or between applications and the feature system 200. Data exchange formats 206 may provide software-independent and/or hardware-independent ways of storing, transporting, and/or sharing data. In other words, these data exchange formats 206 may prevent incompatibility such that data is not lost when aspects of the network environment 100 change (e.g., changes to an operating system or applications such as web browser applications or client-side applications 120). The data exchange format 206 may allow varying degrees of serialization (e.g., object serialization) for the data represented by the data exchange format 206 to be stored (e.g., by the storage 230). In some examples, the features 202 have a data exchange format 206 of JavaScript Object Notation (JSON). In other examples, the features 202 have a data exchange format 206 of Extensible Markup Language (XML). Other examples of possible data exchange formats 204 include RDF, Atom, YAML ain′t markup language/Yet another markup language (YAML), or Rebol. Optionally, the feature system 200 may use different data exchange formats 206 for different types of features 202.

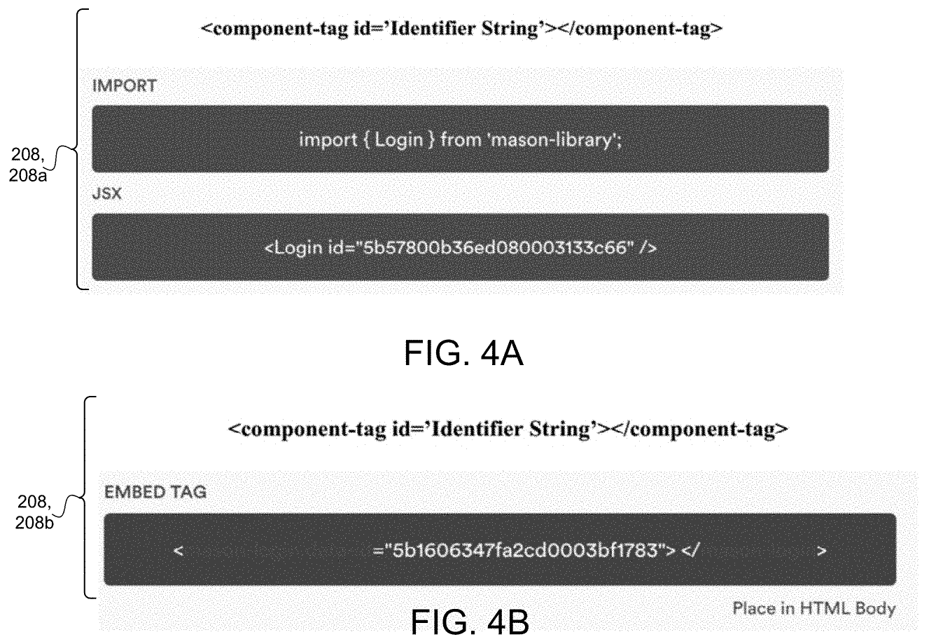

In some configurations, the feature 202 includes a feature identifier 208 (e.g., a unique identifier (UID) as shown in FIGS. 4A and 4B). The feature identifier 208 is generally configured to identify a feature 202 that has been selected by the system user 20 (i.e., a feature 202 of a feature selection 22). In some examples, a feature 202 receives a feature identifier 202 whenever the feature 202 is subject to a feature selection 200. In other examples, the feature 202 receives a feature identifier 202 only when the system user 20 generates (i.e., builds) a user-created feature 202 (e.g., a customized feature 202) such that the default configuration for the feature 202 has been modified by the system user 20. In some examples, the feature identifier 208 is a JavaScript snippet. In other examples, the feature identifier 208 is XML tag. Although the feature identifier 208 may often be a XML tag or a JavaScript snippet, the feature identifier 208 may take other forms to identify the feature 202 such as a filename or a number.

In some implementations, the feature identifier 208 is a key-value pair. For instance, the key of the key-value pair is a specific parameter recognizable by the library 240. In some configurations, the key of the key-value pair is a specific parameter understood by a script retrieved from the network 130 (e.g., a content delivery network). The value in the key-value pair may be a specific object that corresponds to the parameter of the key. In some implementations, the value in the key-value pair is a string of characters (e.g., a set number of characters, such as, for example, 24 characters). For example, FIG. 4A illustrates a key-value pair 208, 208a that could be understood by a JavaScript library while FIG. 4B illustrates a key-value pair 208, 208b that could be understood by a script retrieved from a CDN and delivered over HTTP.

The storage 230 is configured to store features 202 and/or data characteristics associated with the features 202, such as feature configuration data 204, data exchange formats 206, and/or feature identifiers 208. The storage 230 may include one or more databases 232 (e.g., a single database, a cluster of databases, or a data store). In some implementations, a portion or all of the storage 230 is hosted on the remote system 150 using resources 152. Here, although the storage 230 may be hosted remotely (e.g., across one or more distributed storage systems), the storage 230 is in communication with one or more of the other subsystems 210, 220, 240 of the feature system 200. In some configurations, the storage 230 includes a static file server that functions as a repository (e.g., a networked repository) for data related to the feature system 200. The static file server may allow content (e.g., stored features 202 such as completed or built features 202) to be accessible to or delivered to users (e.g., client users 10 or system users 20) without further generation, modification, or processing.

In some implementations, the storage 230 is partitioned in different ways (e.g., to simplify retrieval and/or access). Some examples of possible partitions for the storage 230 are by feature type, data exchange format type, system user 20, designated client-side application 120, or projects of a system user 20 (e.g., by a project identifier). These partitions may function as sandboxes to isolate or to control who (e.g., which system users 20) and/or what data is allowed in each partition. In other words, the storage 230 may be partitioned to prevent system users 20 from accessing proprietary features 202 or more generally entire proprietary projects (with multiple features 202) associated with another system user 20.

Different subsystems 210-240 may be configured to communicate with the storage 230. For instance, some subsystems 210-240 are configured to read from the storage 230 while others are configured to write to the storage 230. In yet other cases, one or more subsystems 210-240 are configured to both read and write to the storage 230. In some configurations of the feature system 200, the interface 210 is the only subsystem 210-240 of the feature system 200 that directly communicates (e.g., reads and writes) with the storage 230. Here, the interface 210 acts as a central hub for other subsystems 220-240 to make storage related requests. By acting as a central hub, the interface 210 may prevent issues with more than one subsystem 210-240 communicating with the storage 230 simultaneously (e.g., for an identical data object).

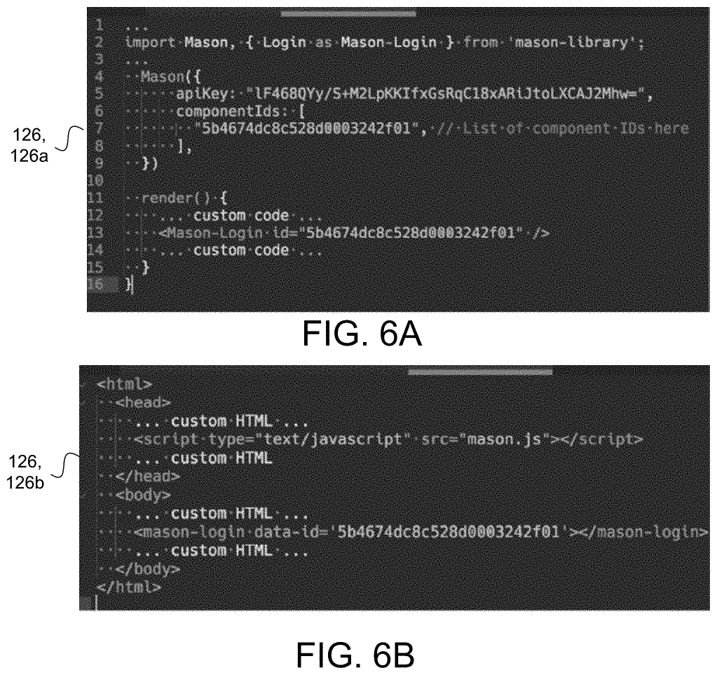

The library 240 generally refers to a subsystem of the feature system 200 that is configured to function as a delivery mechanism. As a delivery mechanism, the library 240 may act as an intermediary and/or a connective layer between components of the network environment 100. For instance, in some aspects, the library 240 acts as an intermediary between the interface 210 and the client-side application 120 to assist the client-side application 120 in rendering features 202 (e.g., forming elements 124 from features 202). In other words, the library 240 is generally configured not to contain features 202, but rather includes software or code to retrieve features 202 that a system user 20 generates with the feature system 200 in order to embed or to render the features 202 at an application (e.g., the client-side application 120). In some implementations, all or a portion of the library 240 resides on a software registry associated with the client-side application 120. In other words, the library 240 may be embedded within a codebase 126 (i.e., source code) for an application (e.g., the client-side application 240), such that, when the application runs, specific functionality of the library 240 may occur. For example, FIGS. 6A and 6B illustrate codebases 126, 126a-b that execute to enable the library 240 to collect feature identifiers 208. More particularly, the library 240 may be embedded in the codebase 126 of the application (e.g., the client-side application 120) at build-time or run-time for the application. In some configurations, the library 240 is hosted outside of an application (e.g., the client-side application 120) such that a script embedded within the codebase 126 of the application may communicate with the library 240 when the script executes. For instance, the script retrieves the library 240 via the network 130 (e.g., a content delivery network) from a remote system 150. In some implementations, the system user 20 includes the library 240 as a dependency in the codebase configuration of the client-side application 120. As a designated dependency, when the client-side application 120 loads at build-time, the code (e.g., source code) associated with the client-side application 120 generates the library 240. As an example, the library 240 may be a JavaScript-based library, including but not limited to constraint programming, document object model (DOM) oriented, graphical, visual, scalable vector graphics (SVG)-related, GUI-related, pure JavaScript, template systems, unit testing, web-application-related, etc. In other examples, the library 240 could be configuration data, documentation, pre-written code, subroutines, classes, values, type-specifications, etc.

FIG. 2B illustrates various processes related to the feature system 200. Here, the interactions between the system user 20, the feature system 200, and each application 120, 140 may correspond to processes such as feature creation, feature editing, feature publishing, and/or feature exporting. To initially create a feature 202, the system user 20 selects a feature 202 to build (e.g., by a feature selection 22). Based on the feature selection 22 by the system user 20, the builder 220 creates a data exchange format 206 (e.g., a JSON representation) of the selected feature 22. In some examples, the builder 220 generates other feature characteristics when creating the data exchange format 206 for the feature 202, such as feature configuration data 204 corresponding to the feature 202 and/or a feature identifier 208 (e.g., configuration data 204 as shown in FIG. 5B). In some examples, when the builder 220 generates the data exchange format 206 or other feature characteristics, the builder 220 is configured to present the feature 202 to the system user 20 in the builder interface 228 (e.g., on the blank canvas 226). This may allow the system user 20 to have a visual understanding of the feature building process as the builder interface 228 may include a GUI representing the feature 202. With the selected feature 22, the system user 20 may decide to modify or to change the feature 202 (e.g., user interface elements of the feature 202). Modifications may add, remove, or edit aspects of the feature 202. In other words, modifications may be different types of edits to the feature 202. Some examples of the types of edits that may occur to the feature 202 include connectivity edits, visual/style edits, or content edits among others. In some examples, the system user 20 adds or modifies file assets associated with the feature 202 (e.g., images, font files, etc.). Here, file assets may be retrieved using a content delivery network 130 (e.g., communicating with a remote network 150). Based on various changes to the feature 202, the builder 220 updates the data exchange format 206 (e.g., JSON configuration) associated with the feature 202. In some examples, the builder 220 is configured to determine whether the feature selection 22 indicates a change to the feature 202 corresponding to the feature selection 22. In other examples, the selection itself provides an indication that the feature selection 22 corresponds to a change to the feature 202 of the selection 22 such that the builder 220 does not need to determine whether a change is present.

In some configurations, when the feature selection 22 indicates a change to the feature 202, the builder 220 may map the change to an appropriate web-development language (e.g., JavaScript, HTML, CSS, etc.) based on the type of edit associated with the change. For example, when the change is a connectivity edit, the builder 220 maps the change to a valid JavaScript. As another example, when the change is a visual edit, the builder 220 maps the change to a valid CSS and a valid HTML. In yet other examples, when the change is a content edit, the builder 220 maps the change to a valid HTML, much like a visual edit. By processing the change (e.g., a change to the data exchange format 206) into a web-development language, the feature system 200 may transmit the web-development language corresponding to the data exchange format to the codebase 126 of the client-side application 120. After the system user 20 has completed modifying the selected feature 202, the builder 220 communicates an updated data exchange format 206 to the storage 230 (e.g., by using the interface 210). In some examples, the interface 210 is the only subsystem component of the feature system 200 that can write to the storage 230 such that in order to store the updated feature 202 (or a characteristic of the updated feature 202) in storage 230, the builder 220 uses the interface 210 to communicate with the storage 230.

In some implementations, the system user 20 makes changes to the feature 202 by configuring one or more external API to integrate with the feature 202. Here, the system user 20 may specify where to retrieve data or input data related to an external API. For example, a feature 202 is configured to receive and/or to send map data to a navigation API, such as GOOGLE MAPS. Additionally or alternatively, the system user 20 may configure rules for applying data retrieved from external APIs to elements of the feature 202 in order to modify these elements dynamically at runtime (e.g., at the client-side application 120).

In some examples, the interface 210 is configured to assign the feature identifier 208 to the selected feature 22. The interface 210 may assign the feature identifier 208 when the feature 202 is initially selected or after the feature 202 has completed its most recent edits. When the interface 210 assigns a feature identifier 208 to the selected feature 22, the interface 210 may create (i.e., write) a record of the feature identifier 208 in storage 230. In some implementations, a modified or an updated data exchange format 206 is formed simply by assigning a feature identifier 208 to a default data exchange format 204 (e.g., from a pre-built feature 202).

In some configurations, the system user 20 indicates that he/she is finished making edits to the selected feature 22 (e.g., the system user 20 is ready to publish a completed feature 202). Here, this indication may trigger the interface 210 to communicate the updated data exchange format 206 associated with the selected feature 22 to storage 230 (e.g., a database 232 associated with the selected feature 22 or a relevant partition of the storage 230). By indicating the changes to the selected feature 22 are complete, the interface 210 publishes the changes to storage 230 to enable the updated feature 202 to be rendered by a client-side application 120 during build-time or runtime of the application.

During feature exporting, the system user 20 indicates a decision to export a feature 202 (e.g., a stored feature 202 or a newly created/edited feature 202). In some examples, the system user 20 selects to export the feature 202 at the builder 220. When the system user 20 decides to export the feature 202, the builder 220 is configured to expose the feature identifier 208 for the feature 202 to the system user 20. By exposing the feature identifier 208, the system user 20 is able to copy the feature identifier 208 for the feature 202 and use the feature identifier 208 as he or she sees fit. For instance, the system user 20 adds the copied feature identifier 208 to an application that the system user 20 is developing (e.g., the client-side application 120). In some examples, the feature exporting process subsequently triggers the feature embedding process described in further detail below.

Referring to FIG. 2C, in some implementations, during development of the client-side application 120 by the system user 20 (e.g., using the feature system 200 and/or the designer-developer application 140), the system user 20 performs an embedding process. Here, the system user 20 may begin the embedding process by including the library 240 as a dependency in a codebase configuration associated with the client-side application 120. Based on this dependency, during build-time for the client-side application 120, the codebase configuration retrieves the library 240 (e.g., from a software registry) and includes the library 240 in the codebase 126 of the client-side application 120. For example, FIG. 2C depicts the library 240 within the codebase 126 of the client-side application 120. In some examples, when the client-side application 120 is a web-based application or a mobile application, the codebase 126 for the client-side application 120 resides on a server (e.g., a computing resource 152 of the remote system 150) that includes at least part of the resources to host the client-side application 120. This enables the client-side application 120 to be accessible from a networked device (e.g., a client device 110a).

In some implementations, in addition to including the library 240 in the codebase 126 of the application, the system user 20 includes one or more feature identifiers 208 for the features 202 that will be used to form the front-end elements 124 of the client-side application 120 in the codebase 126 (e.g., at a desired render location of the codebase 126). With the feature identifiers 208, the feature system 200 and the client-based application 120 can use a call and response function to render features 202 at the client-side application 120. For instance, when the system user 20 makes the codebase 126 of the application 120 available, a client user 10 is able to access the client-side application 120 and execute the codebase 126 of the client-side application 120 to retrieve the library 240 and/or one or more feature identifiers 208. In other words, when the system user 20 publishes the application 120 or website corresponding to the application 120 such that an application server is available over an application layer protocol (e.g., Hypertext Transfer Protocol (HTTP) or secure Hypertext Transfer Protocol (HTTPS)), the client 10 may use the feature identifiers 208 embedded in the codebase 126 of the client-side application 120 to render the front-end elements 124 of the client-side application 120 at runtime.

In some examples, to render the elements 124 of the client-side application 120, the feature system 200 accepts requests 128 (e.g., over an application layer protocol such as HTTP or HTTPS) from a client-side application 120 for features 202 that construct front-end elements 124. For instance, the request 128 requests the system user's feature configurations for features 202 corresponding to one or more front-end elements 124 of a front-end user interface 122 using at least one identifier 208. The requests 128 generated by the client-side application 120 may be made by the library 240 to the interface 210. Here, the feature system 200 may be configured such that the library 240 is not aware of the storage 230 and uses the interface 210 as a simplified intermediary to fetch features 202 based on the feature identifier 208. In some configurations, the library 240 is configured to directly access data within a static file server associated with the storage 240 (e.g., shown as a dotted arrow between the library 240 and the database 232 of the storage 230). This approach may reduce communication lag between subsystems of the feature system 200 and, in some instances, be used for larger data or more complicated data, such as static media file assets (e.g., images, video, font files, etc.), that the system user 20 associates with a feature 202. In some examples, the request 128 is a page load request (e.g., that occurs during runtime of the client-side application 120) for a page associated with the application (e.g., a webpage of the application). Based on the request 128, the feature system 200 responds with feature configuration data 204 (e.g., in the form of a data exchange format 206 for the feature configuration data 204).

At runtime for the application, the library 240 is configured to locate some or all instances of features 202 (e.g., often by feature identifies 208) in the codebase 126 associated with the client-side application 120. For instance, the library 240 may search the client-side application's rendered Document Object Model (DOM) and find all object elements with a corresponding feature identifier 208. In some configurations, the library 240 is configured to distinguish between features 202 that have already been cached during a previous execution of the codebase 126 and new or updated features 202 that have not been previously cached. Here, the library 240 may only request feature configuration data 204 for new or updated features 202. Based on a determination (e.g., by the library 240) that feature configuration data 204 is required to render elements 124 of the client-side application 120, the feature system 200 (e.g., at the interface 210) receives the request 128 as a call to retrieve such feature configuration data 204. In some configurations, the request 128 to the feature system 200 includes the feature identifier 208 for each feature 202 incorporated in the elements 124 of the client-side application 120, such that the interface 210 retrieves (e.g., from storage 230) feature configuration data 204 (e.g., packaged as a data exchange format 206) that has a feature identifier 208 that matches the request identifier 128i.

In some implementations, the request 128 includes a project identifier. A system user 20 or the feature system 200 may generate a project identifier for a project when the feature system 200 builds features 202. In other words, a project may correspond to the application being built by the system user 20 using the feature system 200 and the project may be assigned a project identifier (e.g., a random project identifier when the project is initiated). In some examples, the project identifier corresponds to a folder with feature identifiers 208 for features 202 used in the client-side application 202. This folder may be located at the feature system 200 such that the feature system 200 (e.g., at the interface 210) matches the project identifier of the request 128 with a project identifier located at the feature system 200 and then respond to the request 128 with features 202 associated with or linked to the project identifier (e.g., much like how the feature system 200 may respond to a request 128 that includes a feature identifier 208).

In some examples, with the feature configuration data 204 from the response to the request 128, the library 240 is configured to transform the feature configuration data 204 into a valid web-development language (e.g., HTML, JavaScript, or CSS) for rendering at the application 120. Here, the feature configuration data 204 may be in the form of a data exchange format 206 such as a JSON configuration. In some examples, the library 240 uses the application's DOM to provide the valid web-development language from the feature configuration data 204 and other data, such as data from external APIs. In some implementations, after the library 240 parses the feature configuration data 204 into valid web-development language (e.g., HTML/JavaScript/stylesheets are attached to features 202), the client-side application 120 loads with one or more features 202 such that the client user 10 views a fully functional and/or styled front-end user interface 122 with the incorporated features 202.

In some examples, the feature system 200 and/or the designer-developer application 140 have mechanisms to secure the feature system 200. For instance, in some implementations, the system user 20 has to be an authorized system user 20 of the feature system 200. In order to be an authorized system user 20, a system user 20 may initially receive credentials for the designer-developer application 140 and/or the feature system 200 that may function to authenticate the system user 20 and to authorize the system user 20 to access the feature system 200. The system user 20 may receive credentials by signing up for the feature system 200, subscribing to the feature system 200 (e.g., a paid subscriber), or being invited to use the feature system 200. Beyond general credentials that permit access to the feature system 200, the system user 20 may also have additional credentials or add-ons to his or her credentials to access various projects (e.g., depending on the degree of desired security for the project). Credentials by project may allow system users 20 to collaborate across projects and/or maintain varying levels of access within a single project.

Some other types of security within the network environment 100 include security for data transfers. In some examples, data transfers (e.g., connecting user data to start the application build process and/or data transfers between a user's codebase and the interface 210) are secured by encryption. For example, the data transfers may be encrypted using Secure Sockets Layer (SSL), Transport Layer Security (TLS), or any other encryption technique for data transfer. In some configurations, as part of the credentials for a system user 20, the system user 20 receives an API key 24. The API key may generally allow the system user 20 to provision features 202 for a client-side application 120. In addition to being able to provision features 202, the API key 24 provides security for data transfers between the client-side application 120 and the feature system 200. In order to provide this type of security, the system user 20 may include the API key 24 in the codebase 126 (e.g., in addition to the library 240 and/or the feature identifiers 208) for the client-side application 120. Therefore, when codebase 126 executes, the API key 24 is provided to the library 240 to make calls (i.e., requests 128) on behalf of the system user 20. In other words, the API key 24 functions as an initialization to the call and response process that renders features 202 for the client-side application (e.g., as shown in FIG. 2C).

Optionally, the system user 20 may use machine learning programs/algorithms to collect and/or to analyze the intelligent analytics data from a one or more applications employing a particular feature 202. The information gathered by machine learning can be used to create recommendations for the system user 20 when modifying the particular feature 202 or generating a new feature 202 (e.g., as to how to build that particular feature to obtain certain outcomes or results at the client-side or client-side application 120). For instance, when the system user 20 creates a new account creation feature that includes, for example, an opt-in field to subscribe to a newsletter, and the system user 20 expresses a desire to maximize the number of newsletter opt-ins during account creation in the feature 202, the feature system 200 and/or the designer-developer application 140 may make recommendations to the system user 20 in real time during feature build to optimize newsletter opt-ins during account creation with feature recommendations, such as optimal size, placement, content, or color.

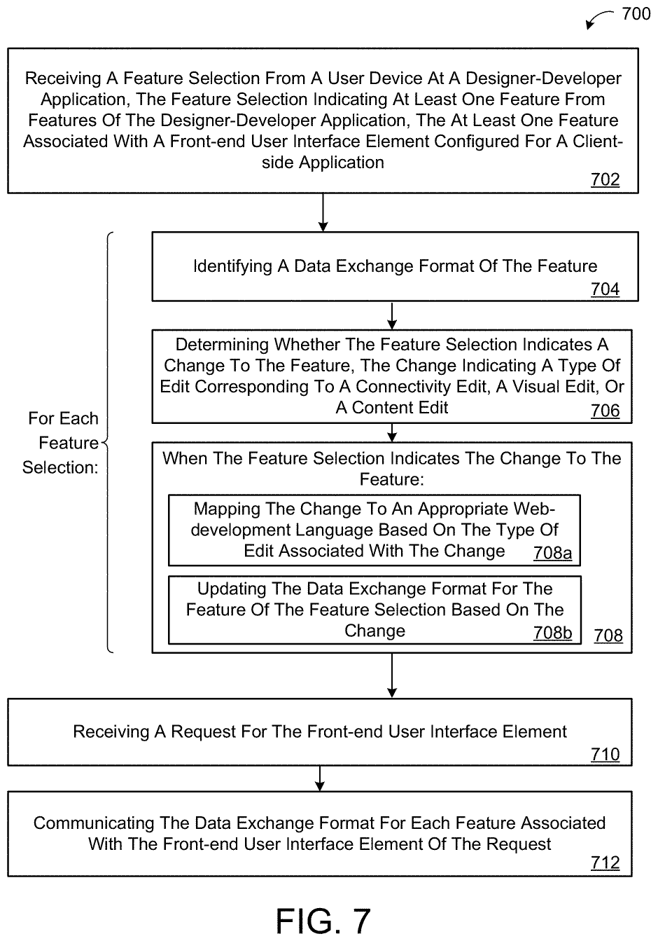

FIG. 7 is an example of a method 700 of translating user inputs (e.g., system user selections 22) into discretely functional styled standalone features 202. At operation 702, the method 700 receives a feature selection 22 from a user device 110 at a designer-developer application 140. Here, the feature selection 22 indicates at least one feature 202 from features of the designer-developer application 140. The at least one feature 202 is associated with a front-end user interface element 124 configured for a client-side application 120. The method 700 performs each operation 704-708 for each feature selection 22. At operation 704, the method 700 identifies a data exchange format 204 of the feature 202. At operation 706, the method 700 determines whether the feature selection 22 indicates a change to the feature 202 where the change indicates a type of edit corresponding to a connectivity edit, a visual edit, or a content edit. At operation 708, 708a-b, when the feature selection 22 indicates the change to the feature 202, the method 700 maps the change to an appropriate web-development language based on the type of edit associated with the change (at operation 708a) and updates the data exchange format 204 for the feature selection 22 based on the change (at operation 708b). At operation 710, the method 700 receives a request 128 for the front-end user interface element 124. At operation 712, the method 700 communicates the data exchange format 204 for each feature associated with the front-end user interface element 124 of the request.

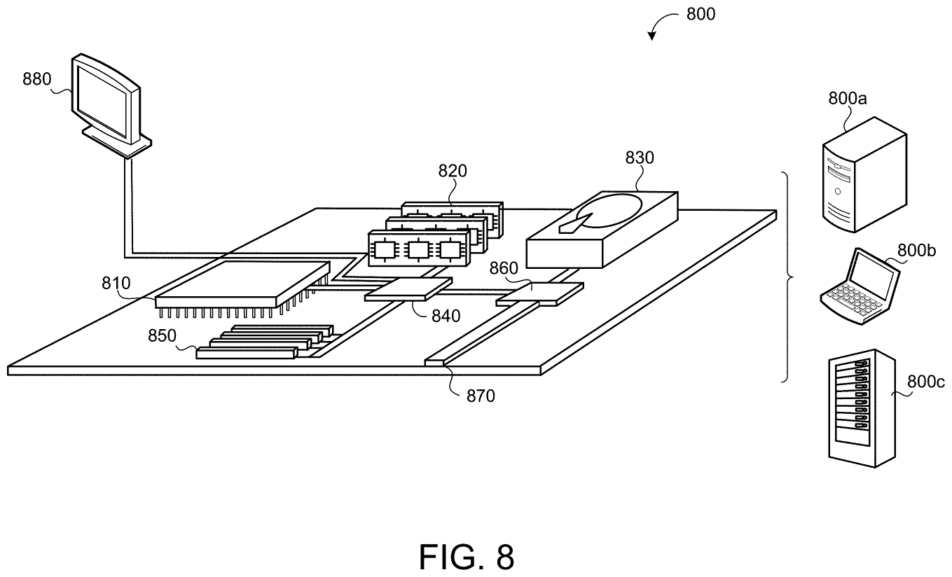

FIG. 8 is schematic view of an example computing device 800 that may be used to implement the systems (e.g., the feature system 200 and/or the systems related to applications 120, 140) and methods (e.g., method 700) described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to a low speed bus 870 and a storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port 890. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method comprising:
receiving, at data processing hardware, a feature selection from a user device at a designer-developer application, the feature selection indicating at least one feature from a features of the designer-developer application, the at least one feature associated with a front-end user interface element configured for a client-side application;
for each feature of the feature selection:
identifying, by the data processing hardware, a data exchange format of the feature;
determining, by the data processing hardware, whether the feature selection indicates a change to the feature, the change indicating a type of edit corresponding to a connectivity edit, a visual edit, or a content edit;
when the feature selection indicates the change to the feature:
mapping, by the data processing hardware, the change to an appropriate web-development language based on the type of edit associated with the change; and
updating, by the data processing, the data exchange format for the feature of the feature selection based on the change;
receiving, at the data processing hardware, a request for the front-end user interface element; and
communicating, by the data processing hardware, the data exchange format for each feature associated with the front-end user interface element of the request.

2. The method of claim 1, wherein the request initiates from a page load request at run-time for a page of the client-side application.

3. The method of claim 2, wherein the page load request includes an authentication key, the authentication key authenticating access for the client-side application to retrieve one or more data exchange formats from the designer-developer application.

4. The method of claim 2, wherein the page load request includes a project identifier indicating one or more front-end user interface elements embedded in the client-side application.

5. The method of claim 1, wherein the data exchange format is a java script object notation (JSON) format.

6. The method of claim 1, wherein the data exchange format is an extensible markup language (XML) format.

7. The method of claim 1, wherein communicating the data exchange format for each feature comprises:
processing the data exchange format into a respective web-development language; and
transmitting the respective web-development language corresponding to the data exchange format to a codebase of the client-side application.

8. The method of claim 1, wherein the front-end user interface element includes a plurality of features.

9. The method of claim 1, wherein receiving the feature selection occurs at a graphical user interface of the designer-developer application.

10. The method of claim 1, wherein the data exchange format includes an identifier for the feature and wherein the request for the front-end user interface element includes at least one request identifier, and the method further comprises:
determining, by the data processing hardware, that the at least one request identifier of the request matches a respective identifier associated with a respective feature of the designer-developer application, and
wherein communicating the data exchange format for each feature associated with the front-end user interface element of the request comprises communicating the data exchange format with the respective identifier that matches the at least one request identifier.

11. The method of claim 1, wherein mapping the change to the appropriate web-development language based on the type of edit associated with the change comprises:
when the change is the connectivity edit, mapping the change a valid java script;
when the change is the visual edit, mapping the change to a valid cascading style sheets (CSS) and a valid first hyper-text markup language (HTML); and
when the change is the content edit, mapping the change to a valid second hyper-text markup language (HTML).

12. The method of claim 1, wherein identifying the data exchange format of the feature further comprises:
identifying a default data exchange format from the features of the designer-developer application corresponding to the feature; and
forming the data exchange format for the feature by assigning a unique identifier (UID) to the default data exchange format corresponding to the feature.

13. A system comprising:
data processing hardware;
memory hardware in communication with the data processing hardware, the memory comprising instructions that when executed by the data processing hardware perform operations, the operations comprising:
receiving a feature selection from a user device at a designer-developer application, the feature selection indicating at least one feature from features of the designer-developer application, the at least one feature associated with a front-end user interface element configured for a client-side application;
for each feature of the feature selection:
identifying a data exchange format of the feature;
determining whether the feature selection indicates a change to the feature, the change indicating a type of edit corresponding to a connectivity edit, a visual edit, or a content edit;
when the feature selection indicates the change to the feature:
mapping the change to an appropriate web-development language based on the type of edit associated with the change; and
updating the data exchange format for the feature of the feature selection based on the change;
receiving a request for the front-end user interface element; and
communicating the data exchange format for each feature associated with the front-end user interface element of the request.

14. The system of claim 13, wherein the request initiates from a page load request at run-time for a page of the client-side application.

15. The system of claim 14, wherein the page load request includes an authentication key, the authentication key authenticating access for the client-side application to retrieve one or more data exchange formats from the designer-developer application.

16. The system of claim 14, wherein the page load request includes a project identifier indicating one or more front-end user interface elements embedded in the client-side application.

17. The system of claim 13, wherein the data exchange format is a java script object notation (JSON) format.

18. The system of claim 13, wherein the data exchange format is an extensible markup language (XML) format.

19. The system of claim 13, wherein the operation of communicating the data exchange format for each feature comprises:
processing the data exchange format into a respective web-development language; and
transmitting the respective web-development language corresponding to the data exchange format to a codebase of the client-side application.

20. The system of claim 13, wherein the front-end user interface element includes a plurality of features.

21. The system of claim 13, wherein receiving the feature selection occurs at a graphical user interface of the designer-developer application.

22. The system of claim 13, wherein the data exchange format includes an identifier for the feature and wherein the request for the front-end user interface element includes at least one request identifier, and the operations further comprise:
determining that the at least one request identifier of the request matches a respective identifier associated with a respective feature of the designer-developer application, and
wherein communicating the data exchange format for each feature associated with the front-end user interface element of the request comprises communicating the data exchange format with the respective identifier that matches the at least one request identifier.

23. The system of claim 13, wherein the operation of mapping the change to the appropriate web-development language based on the type of edit associated with the change comprises:
when the change is the connectivity edit, mapping the change a valid java script;
when the change is the visual edit, mapping the change to a valid cascading style sheets (CSS) and a valid first hyper-text markup language (HTML); and
when the change is the content edit, mapping the change to a valid second hyper-text markup language (HTML).

24. The system of claim 13, wherein the operation of identifying the data exchange format of the feature further comprises:
identifying a default data exchange format from the features of the designer-developer application corresponding to the feature; and
forming the data exchange format for the feature by assigning a unique identifier (UID) to the default data exchange format corresponding to the feature.
